(19) United States
(12) Patent Application Publication
(10) Pub. No.: US 2019/0242966 A1
(43) Pub. Date: Aug. 8, 2019

(54) PROXIMITY DETECTION UTILISING LOCATION BEACONS

(71) Applicant: Coventry University, Coventry (GB)

(72) Inventor: Mark Tyers, Coventry (GB)

(73) Assignee: Coventry University, Coventry (GB)

(21) Appl. No.: 16/331,760

(22) PCT Filed: Sep. 5, 2017
(86) PCT No.: PCT/GB2017/052571

§ 371 Date: Mar. 8, 2019

(30) Foreign Application Priority Data
Sep. 8, 2016 (GB) 1615271.2

(51) Int. Cl. G01S 1/06; G01S 1/04; H04W 4/02; H04W 4/80; H04B 5/00; H04W 64/00; H04W 8/26

(52) U.S. Cl. CPC G01S 1/06; G01S 1/042; H04W 4/025; H04W 8/26; H04B 5/0068; H04W 64/003; H04W 4/80

(57) ABSTRACT

User devices (1-4) are each provided with a data connection (20) to a remote server (30) and a beacon transceiver. Device (2) is operable to actively transmit beacon signals including its unique beacon identification code for a limited period. During active transmissions by device (2), devices (1 & 3) are within range of the transmissions and are operable to extract the beacon identification code of the transmitting device (2) and thus directly infer that they are in proximity to the transmitting device (2). The receiving devices (1, 3) communicate with server (30) their own unique beacon identification code and the received beacon identification code of the transmitting device (2). In response, the server (30) communicates details of the transmitting device (2) to the receiving devices (1, 3) and the beacon identification codes of the receiving devices (1, 3) to the transmitting device (2). The transmitting device (2) is thus able to infer the proximity of the receiving devices (1, 3) without the receiving devices (1, 3) having to transmit any beacon signals.

### TECHNICAL FIELD OF THE INVENTION

The present invention relates to proximity detection and in particular to proximity detection services utilising location beacons and most particularly to proximity detection services for user devices utilising location beacon technology.

### BACKGROUND TO THE INVENTION

It is known to provide proximity detection services and/or to activate location dependent actions or services on suitably equipped user devices such as smartphones, tablets or the like by reference to location beacons. For example, these may be location beacons operable according to the Bluetooth Low Energy protocol such as those supplied under the names iBeacon and Eddystone.

In use, one or more beacons are provided in fixed locations, each beacon operable to emit a short range wireless signal including a unique beacon identification code. Upon receipt of the unique identification code, the user device is operable to look up the identification code and thereby determine that the user device is within range of the beacon with the received identification code. Typically, the look up is performed by an application running on the user device. The look up may be performed within the user device memory but is more commonly performed on a remote server accessed using the data connection of the user device. Once the beacon is identified and the proximity of the user device to the identified beacon is thus determined, this can trigger another action such as the pushing of a marketing or information message to the user device via the data connection.

In addition to passively detecting beacons, many user devices are capable of acting as a beacon. In such cases, the device is operable to emit a wireless signal including a unique identification code which may be detected by other devices within range of the transmissions. In response, said detecting devices may seek to exchange information with the transmitting device and/or one or more proximity based actions may be initiated. Once beacon transmissions cease, the devices may be mutually undetectable and hence information exchange and proximity based actions cease.

Maintaining the constant signal transmissions necessary to act as a beacon utilises a considerable amount of power and such action tends to reduce device battery life significantly. Indeed, many devices are operable to automatically cease transmissions after a short period and subsequently operate in passive mode. This typically occurs even if active transmission mode is selected. In view of the above, there is a significant limitation placed upon the practical use of beacon functionality in user devices for direct proximity detection.

It is therefore an object of the present invention to address disadvantages of the prior art.

### SUMMARY OF THE INVENTION

According to a first aspect of the present invention there is provided a method of detecting that user devices are in proximity to each other, the method comprising: transmitting a beacon signal including a transmitting device beacon identification code from a first user device; receiving the transmitted beacon signal on another user device; communicating the beacon identification code from the received beacon signal to a remote server along with a receiving device beacon identification code using a data connection; and communicating the receiving device beacon identification code to the transmitting device using a data connection.

In this manner, the receiving device may be operable to determine the proximity of the transmitting device by direct detection of the beacon signal and the transmitting device can determine the proximity of the receiving device by communication along the data connection without requiring the receiving device to activate beacon transmissions.

In the event that multiple devices receive beacon signals from the transmitting device, the method may include each receiving device communicating the received beacon identification code from the received beacon signal to the remote server along with its receiving device beacon identification code. In such embodiments, the method may include the server communicating details of each receiving device beacon identification code to the transmitting device. In this manner, the transmitting device may determine the proximity of multiple receiving devices without any receiving device activating beacon transmissions

In such embodiments, the method may include the server communicating details of each other receiving device beacon identification code to each receiving device. In this manner, each receiving device may infer the proximity of each other receiving device without activating beacon transmissions.

Once a device is inferred to be in proximity to one or more other devices, the method may maintain said inference for a threshold interval from the initial determination. This ensures that proximity inferences may be maintained for a time after beacon transmissions cease. The threshold interval may be fixed or may be variable. If the threshold interval is variable, it may be varied in response to any one or more of: proximate device identity; user identity associated with the proximate device; user input; motion detection or the like.

In some embodiments, the method may include prompting one or more devices to transmit beacon signals in response to the expiry of the threshold interval.

In the event that one receiving device is inferred to be in proximity to other devices prior to receiving a beacon signal, the method may include the step of communicating the beacon identification codes of the other proximate devices to the server via the data connection. In such cases, the method may further include the server communicating details of each other receiving device beacon identification code and each prior proximate device identification code to each receiving device and/or the transmitting device.

In this way proximity can be inferred between devices where both devices are in proximity to at least one common device. In this manner, the effective range of proximity may be expanded. Additionally or alternatively, this may provide some compensation for missed receipt of signals in an area with poor signal transmission characteristics.

Once proximity is inferred, the method may include the step of exchanging information and/or initiating proximity based actions. The step of exchanging information may take place by use of the data connection to the remote server. The method may include outputting details of the devices inferred to be in proximity. The details may be output by way of a display screen provided on the device. The details may be output automatically or in response to user request.

User devices may include but are not limited to smartphones, tablet computers, laptop computers, personal media players, personal digital assistants (PDAs), location beacons or the like. Beacon transmission may include but are not limited to protocols such as Bluetooth low energy, Bluetooth or the like. The data connection may take any suitable form. In particular the data connection may be a wireless data connection to a local internet router or a wireless data connection to a local cellular base station of a cellular data network.

According to a second aspect of the present invention there is provided a user device operable to enable detection of other user devices in proximity thereto, the user device comprising: a data communication unit operable to enable the exchange of data signals with a remote server via a data connection; a beacon transceiver operable to transmit and receive beacon signals; and a proximity module operable to extract beacon identification codes from beacon signals received by the beacon transceiver or data signals received by the data communication unit and output a proximity indication in response thereto, the proximity module further operable in response to the extraction of a beacon identification code from a beacon signal to communicate the received identification code and the receiving device beacon identification code to the remote server via the communication means.

The user device of the second aspect of the present invention may incorporate any or all features of the method of the first aspect of the present invention.

The proximity module may be operable to activate a proximity indication. The proximity indication may be an audio indication a visual indication or a combination of audio and visual indications. Suitable audio indications include single tones, series of tones, sampled or simulated speech music or other sounds. Suitable visual indications include illuminating, constantly or intermittently, indicator lights. Where the user device comprises a display screen, visual indications may additionally or alternatively comprise displaying an indication icon on the display screen.

The proximity module may be operable in response to the extraction of a beacon identification code to activate a linked application provided on the user device. In such implementations, the proximity module may be operable to communicate the beacon identification code to the application. This can enable the application to access data relating to the beacon identification code. Where the user device comprises a display screen, some or all of said data may be subsequently output on the display screen.

In one example, the application may be a social networking application. In such examples, the application may be operable to display information relating to the identity of the detected device or to a user profile associated with the detected device.

In one example, the proximity module may be operable in response to stimulus from the user device. Suitable stimuli include, user inputs, user device sensor outputs, applications running on the user device or the opening of an application on the user device. The proximity module may be operable to initiate beacon transmissions by the beacon transceiver in response to such stimulus.

According to a third aspect of the present invention there is provided a server operable in combination with one or more user devices to enable detection that devices are in proximity to each other, the server comprising: a communication interface operable to exchange data signals with one or more user devices via a data connection; a proximity engine operable to: extract beacon identification codes relating to the communicating user device from data signals received by the communication interface; extract beacon identification codes relating to transmitting user devices detected by the communicating user device; and communicate the beacon identification codes of the communicating user devices to the respective detected transmitting user device via the communication interface.

The server of the third aspect of the present invention may incorporate any or all features of the first and second aspects of the present invention as required or as desired.

The server may be provided with a data store. The data store may be operable to store details relating to multiple beacon identification codes or details of user identities related to multiple beacon identification codes. The data store may be operable to additionally or alternatively store details of communications received or transmitted via the communication interface.

According to a fourth aspect of the present invention there is provided a system comprising: a plurality of user devices according to the second aspect of the present invention and a server according to the third aspect of the present invention.

### DETAILED DESCRIPTION OF THE INVENTION

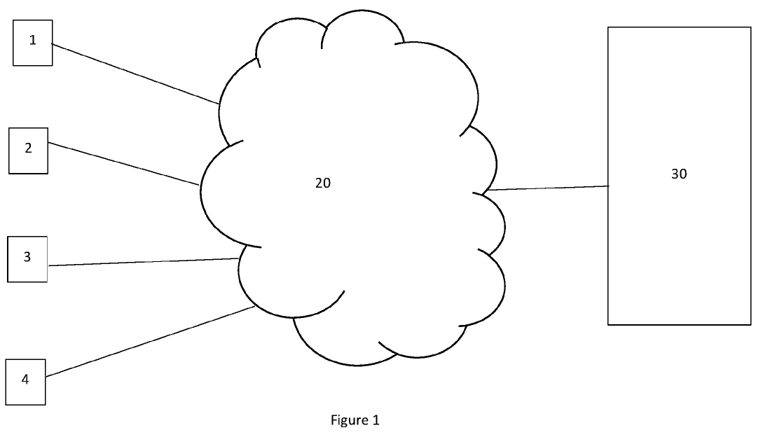

In order that the invention may be more clearly understood an embodiment thereof will now be described, by way of example only, with reference to the accompanying drawings, of which: FIG. 1 is a schematic illustration of multiple user devices operable to determine when they are in proximity to one another according to the method of the present invention;

FIG. 2 is a schematic block diagram of an embodiment of a user device operable to implement the method of the present invention; and

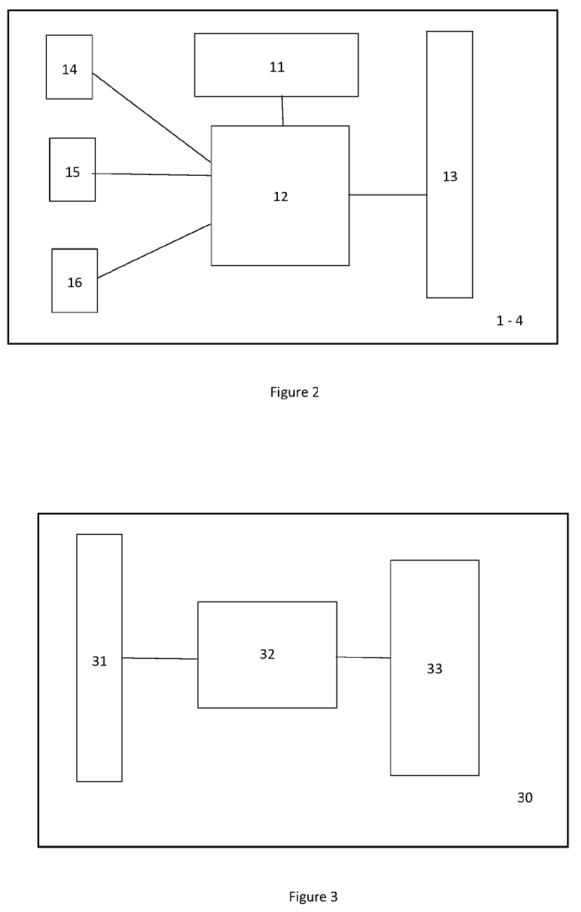

FIG. 3 is a schematic block diagram of an embodiment of a server operable to implement the method of the present invention.

Turning now to FIG. 1, a plurality of user devices 1-4 are each provided with a data connection 20 to a remote server 30. The data connection 20 is typically a cellular data network but may also comprise an internet connection.

The user devices 1-4 typically comprise the likes of smartphones, tablet computers, laptop computers, personal media players or personal digital assistants (PDAs). Each user device is additionally provided with a beacon transceiver operable to both transmit and receive beacon signal. Such beacon signals each include a unique beacon identification code for each device. Typically, the beacon signals conform to a known beacon protocol such as Bluetooth low energy. Nevertheless, alternative beacon protocols may be used if desired.

In the example of FIG. 1, device 2 is operable to actively transmit beacon signals including its beacon identification code for a limited period. This may be as a result of device 2 being set to periodically allow active beacon signal transmissions. It may additionally or alternatively be as a result of user action such as selection of beacon signal transmission mode directly or by opening an application that enables beacon signal transmission mode.

During the period of active transmissions by device 2, devices 1 & 3 are within range of the beacon signals transmitted by device 2. Upon receipt of the signals from device 2, devices 1 & 3 are operable to extract the beacon identification code of the transmitting device 2. Accordingly, devices 1 & 3 can directly infer that they are in proximity to the transmitting device 2.

The receiving devices 1, 3 communicate with server 30 using data connection 20. The communication includes the beacon identification code of the individual receiving device 1, 3 and the received beacon identification code of the transmitting device 2. In response, the server 30 communicates details of the transmitting device 2 or user identities associated with the transmitting device 2 to the receiving devices 1, 3.

Subsequently, the server 30 communicates the beacon identification codes of the receiving devices 1, 3 to the transmitting device 2 via the data connection 20. The server 30 may additionally communicate other information such as details of the receiving devices 1, 3 or user identities associated with the receiving devices 1, 3 to the transmitting device 2. The transmitting device 2 is thus able to infer the proximity of the receiving devices 1, 3 without the receiving devices 1, 3 having to transmit any beacon signals. The present method therefore allows a single burst of beacon transmissions from a single transmitting device 2 to enable the determination of mutual proximity to be made by multiple user devices. This provides a significant energy saving in the use of beacon transmissions as a proximity detection tool.

In order that constant beacon signal transmissions are not required by either the transmitting device 2 or the receiving devices 1, 3 the determination that the devices are in proximity is maintained for a threshold interval. The threshold interval can be fixed at a suitable time period, say 10 minutes. Alternatively, the threshold interval can be varied in response to device actions, such as user inputs, device sensors, such as detecting that the device has moved more than a threshold distance or the identity of other proximate devices.

In the event that a device, such as device 3, was previously determined to be in proximity to another device 4 and is within the threshold interval since this determination was made, the device 3 may be operable to communicate to the server 30 details of the beacon identification code of the device 4. Alternatively, the server may be operable to determine that proximity between devices 3 & 4 was inferred within the threshold interval. In response to either of the above, the server 30 can communicate to device 4, details of devices 1 & 3 such that device 4 can infer it is in proximity to devices 1 & 2 as well as device 3. Similarly, the server 30 can also communicate to devices 1 & 2 details of device 4 such that devices 1 & 2 can infer proximity to device 4.

Whilst the above has been described in terms of beacon signal transmissions by mobile user devices 1-4, it is of course possible that the method may be implemented in response to user devices 1-4 receiving beacon signals transmitted by a dedicated location beacon (not shown). In such cases, in response to the detection of the beacon signals from the location beacon each receiving device can infer proximity to the location beacon. By subsequently communicating the unique beacon identification code of the location beacon to the server 30, it can be inferred that each device 1-4 that receives signals from the location beacon is in proximity to the other devices receiving signals from the same location beacon. The server can thus communicate details relating to each receiving device 1-4 to each of the other receiving devices so that each device can infer proximity to the other receiving devices 1-4 without having to actively transmit beacon signals. Similarly, proximity can be inferred for devices already inferred to be in proximity to any one of devices 1-4 even if they do not directly receive a beacon transmission from the location beacon. In the event that the location beacon is a smart location beacon, it may be operable to receive details of the user devices 1-4 by communication with the server 30.

In one implementation, each of user devices 1-4 may comprise smartphones. When the user of device 2 enters an area, they activate a social networking application on the device 2 in order to determine if any social networking contacts are in proximity. The social networking application automatically activates beacon signal transmissions and the proximity detection method described above is utilised. Consequently, the social networking application can display to the user of device 2 the social network identities associated with devices 1, 3 that directly detected the beacon signals transmitted by device 2 and the social network identities associated with devices such as device 4, that were already inferred to be in proximity to devices 1, 3. The user of device 2 can thus rapidly identify who is present in the area. The user can then choose to look out for persons of interest and/or message the persons of interest using the application (or other means). Similarly, the devices 1, 3, 4 may each be operable to display details of the social network identities associated with device 2 and the other devices 1, 3, 4. Typically, this might involve outputting a proximity indication when a new device is inferred to be in proximity. The users of the receiving device 1, 3, 4 can thus be altered to the entry into the area of the user of device 2.

Turning now to FIG. 2, a schematic block diagram of a user device (such as user devices 1-4) suitable for implementing the above method is shown. The user device 1-4 comprises a beacon transceiver 11, a proximity module 12, and a communication unit 13.

The beacon transceiver 11 is operable to transmit and receive beacon signals. Beacon signals transmitted by the beacon transceiver 11 include the unique beacon identification code of the device 1-4.

The proximity module 12 is operable to extract beacon identification codes from signals received by the beacon transceiver 1. When such codes are extracted, the proximity module 12 is operable to infer that the transmitting device associated with the extracted code is in proximity to the device 1-4. Subsequently, the proximity module is operable to communicate the extracted beacon identification code and the device identification code to the server 30 via the communication means 13.

The communication unit 13 is additionally operable to receive communications from server 30. Where the communications include beacon identification codes, the proximity module 12 is operable to extract said codes from the communication and infer that the user devices associated with said codes are in proximity to the device 1-4. In the event that the communication contains further details of the proximate devices or user identities associated with the proximate devices, the proximity module may be operable to generate an alert indication which can be output upon audio output means 14 and/or visual output means 15 provided on the device. Typically, the audio output means 14 might be a loudspeaker and the visual output means 15, might comprise a display screen and/or an indicator light.

In response to an alert indication, the user of device 1-4 might utilise user input means 16 to cause further details of the proximate devices or the user identities of the proximate devices to be output on the visual output means. Typically, the user inputs 16 might comprise a touch screen interface, a key pad or the like. The user inputs 16 might also be used to input control commands to the proximity module 12 (or to an application associated with the proximity module 12). In response, the proximity module 12 may be operable to activate beacon signal transmission by the beacon transceiver 11.

Turning now to FIG. 3, a schematic block diagram of a server 30 operable to implement the present invention is shown. The server 30 comprises a communication interface 31, a proximity engine 32 and a data store 33. The communication interface 31 is operable to communicate with the user devices 1-4. The communications received via the interface each include the beacon identification code of the communicating user device. Where the communications indicate that the device 1-4 has detected beacon transmissions from another device 1-4, the communications also include the beacon identification code of the transmitting device 1-4.

The proximity engine 32 is operable to extract beacon identification codes from the data signals received via the communication interface 31. In response to received communications including beacon identification codes, the proximity engine 32 is operable to generate data signals to be sent to user devices 1-4 via the communications interface 31. In particular, the proximity engine 32 is operable to communicate the beacon identification codes of the communicating user devices to the respective detected transmitting user device via the communication interface 31. Typically, the proximity engine 32 is additionally operable to communicate details relating to the beacon identification codes alongside the codes.

In addition to the above, the proximity engine 32 may be operable to communicate the beacon identification codes of the communicating user devices detecting a common transmitting user device to each other user device via the communication interface 31. Further the proximity engine 32 may be operable to communicate the beacon identification codes of other proximate devices to one of the communicating devices detecting a common transmitting user device to each other user device via the communication interface 31.

Typically, the proximity engine 32 may be operable to store details of communications received and transmitted in the data store 33. The proximity engine 32 may additionally, be operable to extract details relating to the beacon identification codes in received message from the data store 33 for onward communication.

The above embodiment is described by way of example only. Many variations are possible without departing from the scope of the invention as defined in the appended claims.

1. A method of detecting that user devices are in proximity to each other, the method comprising: transmitting a beacon signal including a transmitting device beacon identification code from a first user device; receiving the transmitted beacon signal on another user device; communicating the beacon identification code from the received beacon signal to a remote server along with a receiving device beacon identification code using a data connection; and communicating the receiving device beacon identification code to the transmitting device using a data connection.

2. A method as claimed in claim 1 wherein multiple devices receive beacon signals from the transmitting device, and the method includes each receiving device communicating the received beacon identification code from the received beacon signal to the remote server along with its receiving device beacon identification code.

3. A method as claimed in claim 2 wherein the method includes the server communicating details of each receiving device beacon identification code to the transmitting device.

4. A method as claimed in claim 2 wherein the method includes the server communicating details of each other receiving device beacon identification code to each receiving device.

5. A method as claimed in claim 1 wherein once a device is inferred to be in proximity to one or more other devices, the method maintains said inference for a threshold interval from the initial determination.

6. A method as claimed in claim 1 wherein the threshold interval is varied in response to any one or more of: proximate device identity; user identity associated with the proximate device; user input; or motion detection.

7. A method as claimed in claim 1 wherein if one receiving device is inferred to be in proximity to other devices prior to receiving a beacon signal, the method includes the step of communicating the beacon identification codes of the other proximate devices to the server via the data connection.

8. A method as claimed in claim 7 wherein the method includes the server communicating details of each other receiving device beacon identification code and each prior proximate device identification code to each receiving device and/or the transmitting device.

9. A method as claimed in claim 1 wherein once proximity is inferred, the method includes the step of exchanging information and/or initiating proximity based actions.

10. A method as claimed in claim 1 wherein the method includes outputting details of the devices inferred to be in proximity.

11. A user device operable to enable detection of other user devices in proximity thereto, the user device comprising: a data communication unit operable to enable the exchange of data signals with a remote server via a data connection; a beacon transceiver operable to transmit and receive beacon signals; and a proximity module operable to extract beacon identification codes from beacon signals received by the beacon transceiver or data signals received by the data communication unit and output a proximity indication in response thereto, the proximity module further operable in response to the extraction of a beacon identification code from a beacon signal to communicate the received identification code and the receiving device beacon identification code to the remote server via the communication means.

12. A user device as claimed in claim 11 wherein the proximity module is operable to activate a proximity indication.

13. A user device as claimed in claim 12 wherein the proximity indication is an audio indication, a visual indication or a combination of audio and visual indications.

14. A user device as claimed in 11 wherein the proximity module is operable in response to the extraction of a beacon identification code to activate a linked application provided on the user device.

15. A user device as claimed in claim 14 wherein the proximity module is operable to communicate the beacon identification code to the application.

16. A user device as claimed in claim 14 wherein the application is a social networking application and is operable to display information relating to the identity of the detected device or to a user profile associated with the detected device.

17. A user device as claimed in claim 11 wherein the proximity module is operable in response to stimulus from the user device including: user inputs, user device sensor outputs, applications running on the user device or the opening of an application on the user device.

18. A user device as claimed in claim 17 wherein the proximity module is operable to initiate beacon transmissions by the beacon transceiver in response to such stimulus.

19. A server operable in combination with one or more user devices to enable detection that devices are in proximity to each other, the server comprising: a communication interface operable to exchange data signals with one or more user devices via a data connection; a proximity engine operable to: extract beacon identification codes relating to the communicating user device from data signals received by the communication interface; extract beacon identification codes relating to transmitting user devices detected by the communicating user device; and communicate the beacon identification codes of the communicating user devices to the respective detected transmitting user device via the communication interface.

20. A server as claimed in claim 19 wherein the server is provided with a data store.

21. A server as claimed in claim 20 wherein the data store is operable to store details relating to multiple beacon identification codes or details of user identities related to multiple beacon identification codes.

22. A server as claimed in claim 20 wherein the data store is operable to store details of communications received or transmitted via the communication interface.

23. A system comprising:
a plurality of user devices comprising: a data communication unit operable to enable the exchange of data signals with a remote server via a data connection; a beacon transceiver operable to transmit and receive beacon signals; and a proximity module operable to extract beacon identification codes from beacon signals received by the beacon transceiver or data signals received by the data communication unit and output a proximity indication in response thereto, the proximity module further operable in response to the extraction of a beacon identification code from a beacon signal to communicate the received identification code and the receiving device beacon identification code to the remote server via the communication means; and
a server comprising: a communication interface operable to exchange data signals with the one or more user devices via a data connection; a proximity engine operable to: extract beacon identification codes relating to the communicating user device from data signals received by the communication interface; extract beacon identification codes relating to transmitting user devices detected by the communicating user device; and communicate the beacon identification codes of the communicating user devices to the respective detected transmitting user device via the communication interface.
